(19) United States
(12) Patent Application Publication
(10) Pub. No.: US 2023/0111930 A1
(43) Pub. Date: Apr. 13, 2023

(54) SYSTEMS, DEVICES AND METHODS FOR CONTROLLING INDUSTRIAL BELT TRACKING

(71) Applicant: GATES CORPORATION, Denver, CO (US)

(72) Inventors: Leslee Brown, Broomfield, CO (US); Thomas S. Moss, III, Englewood, CO (US); Alex Warneke, Denver, CO (US); Chris Wilkins, Englewood, CO (US); Bipinchandra Patel, Rochester Hills, MI (US); James R. Stamp, Elizabethtown, KY (US)

(21) Appl. No.: 17/964,472

(22) Filed: Oct. 12, 2022

Related U.S. Application Data
(60) Provisional application No. 63/254,643, filed on Oct. 12, 2021.

(51) Int. Cl. B65G 15/64; B65G 15/62; B65G 15/50

(52) U.S. Cl. CPC B65G 15/64; B65G 15/62; B65G 15/50

(57) ABSTRACT

A device for controlling industrial belt tracking with a first cylindrical pulley segment having a central opening and a plurality of teeth formed on the outside diameter; a second cylindrical pulley segment having a central opening and having a plurality of teeth formed on the outside diameter; and a flange ring. The flange ring being disposed between the first cylindrical pulley segment and the second cylindrical pulley segment such that the flange ring, the first cylindrical pulley segment and the second cylindrical pulley segment are coaxially aligned. Further, the flange ring is shaped and sized such that the outer diameter edge provides a flange perpendicular to the plurality of teeth formed on the outside diameter surface of the first cylindrical pulley segment and the second cylindrical pulley segment and generally radially aligned with the plurality of teeth formed on the outside diameter surface of the first cylindrical pulley segment and the second cylindrical pulley segment.

### BACKGROUND

Industrial power transmission drives using large extended length (EL) belts may experience belt tracking where the belt moves parallel to the axis of rotation at one or more pulleys included in the industrial power transmission drive, which can lead to damage of the belt and reduce the life span of the belt.

To combat the potential for belt tracking, in some applications, a pulley may include an outer flange to prevent a tracking belt from sliding off the pulley. This tracking movement is shown in FIG. 1, where belt 100 tracks laterally (as shown by arrow 101) towards the flange 111 included at the edge of driver pulley 110. As shown in FIG. 1, the system may include a larger width large pulley 120 opposite the driver pulley 110 to further accommodate belt tracking.

However, the use of pulley with an outer flange, present other challenges. One problem with the use of an outer flange on the driver pulley 110 to address belt tracking is that large tracking forces may be applied by the flange to the belt. This can result in severe belt damage due to the belt wearing against the flange, including total belt failure (e.g., the belt breaking). Additionally, the tracking force may be sufficiently great that the belt will ride up on or even go over the flange thereby the belt may become misaligned with the pulley and cause a malfunction in the drive system.

Accordingly, new solutions are needed for effectively dealing with industrial belt tracking, including solutions that either control or completely inhibit belt tracking.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

In some embodiments, a device for controlling or inhibiting industrial belt tracking includes a first cylindrical pulley segment, a second cylindrical pulley segment, and a flange ring. The first cylindrical pulley segment has a central opening and a plurality of teeth formed on the outside diameter surface thereof. The second cylindrical pulley segment has a central opening and a plurality of teeth formed on the outside diameter surface thereof. The flange ring is disposed between the first cylindrical pulley segment and the second cylindrical pulley segment such that the flange ring, the first cylindrical pulley segment and the second cylindrical pulley segment are coaxially aligned. The flange ring is shaped and sized such that the outer diameter edge of the flange ring provides a flange oriented perpendicular to the orientation of the plurality of teeth formed on the outside diameter surface of the first cylindrical pulley segment and the second cylindrical pulley segment. The flange ring is also sized such that its outer diameter edge is generally radially aligned with the plurality of teeth formed on the outside diameter surface of the first cylindrical pulley segment and the second cylindrical pulley segment.

In some embodiments, a device for controlling or inhibiting industrial belt tracking includes a first cylindrical pulley segment, a second cylindrical pulley segment, and a flange ring. The first cylindrical pulley segment includes a first cylindrical base portion having an outer diameter and an inner diameter, and a first cylindrical flange portion extending axially away from an interior end of the first cylindrical base portion. The first cylindrical flange portion has an inner diameter less than the inner diameter of the first cylindrical base portion and an outer diameter less than the outer diameter of the first cylindrical base portion. The second cylindrical pulley segment includes a second cylindrical base portion having an inner diameter and an outer diameter, and a second cylindrical flange portion having an outer diameter approximately equal to the outer diameter of the second cylindrical base portion and an inner diameter greater than the inner diameter of the second cylindrical base portion. The flange ring has an inner diameter approximately equal to the outer diameter of the first cylindrical flange portion and an outer diameter approximately equal to the outer diameter of the first cylindrical base portion and the second cylindrical flange portion. The inner diameter surface of the second cylindrical flange portion resides against the outer diameter surface of the first cylindrical flange portion, and the flange ring is disposed between the interior end of the first cylindrical base portion and an interior end of the second cylindrical flange portion.

In some embodiments, a device for controlling or inhibiting industrial belt tracking includes a first cylindrical pulley segment, a second cylindrical pulley segment, and a flange ring. The first cylindrical pulley segment includes a first cylindrical base portion having an outer diameter and an inner diameter, and a first cylindrical flange portion extending axially away from an interior end of the first cylindrical base portion. The first cylindrical flange portion has an inner diameter greater than the inner diameter of the first cylindrical base portion and an outer diameter less than the outer diameter of the first cylindrical base portion. The second cylindrical pulley segment has an inner diameter approximately equal to the outer diameter of the first cylindrical flange portion and an outer diameter approximately equal to the outer diameter of the first cylindrical base portion. The axial length of the second cylindrical pulley segment is approximately equal to the axial length of the first cylindrical flange portion. The flange ring has an inner diameter approximately equal to the outer diameter of the first cylindrical flange portion and an outer diameter approximately equal to the outer diameter of the first cylindrical base portion. The inner diameter surface of the second cylindrical pulley segment resides against the outer diameter surface of the first cylindrical flange portion, and the flange ring is disposed between the interior end of the first cylindrical base portion and an interior end of the second cylindrical pulley segment.

In some embodiments, a device for controlling or inhibiting industrial belt tracking includes a cylindrical pulley segment and a flange ring. The cylindrical pulley segment has an opening formed therein, an outer diameter surface, and an inner diameter surface. A groove oriented perpendicular to a rotational axis of the device is formed in the outer diameter surface of the cylindrical pulley segment, the bottom of the groove having a first diameter. A plurality of teeth oriented parallel to the rotational axis of the device are formed in the outer diameter surface of the cylindrical pulley segment. The flange ring has an inner diameter approximately equal to the first diameter of the groove and an outer diameter approximately equal to the outer diameter of the teeth formed in the outer diameter surface of the cylindrical pulley segment. The flange ring may be made from multiple pieces that when assembled together form a closed ring.

These and other aspects of the technology described herein will be apparent after consideration of the Detailed Description and Figures herein. It is to be understood, however, that the scope of the claimed subject matter shall be determined by the claims as issued and not by whether given subject matter addresses any or all issues noted in the Background or includes any features or aspects recited in the Summary.

### BRIEF DESCRIPTION OF THE DRAWINGS

Non-limiting and non-exhaustive embodiments of the disclosed technology, including the preferred embodiment, are described with reference to the following figures, wherein like reference numerals refer to like parts throughout the various views unless otherwise specified.

FIG. 1 is an image of an industrial power transmission drive exhibiting belt tracking as known in the prior art.

FIGS. 2A and 2B are cross-sectional views of a device for controlling or inhibiting industrial belt tracking configured in accordance with various embodiments described herein.

FIG. 3 is a perspective view of an industrial belt suitable for use with various embodiments of the devices described herein for use in controlling or inhibiting industrial belt tracking.

FIG. 4 is a cross-sectional view of a device for controlling or inhibiting industrial belt tracking configured in accordance with various embodiments described herein.

FIG. 5 is a cross-sectional view of a device for controlling or inhibiting industrial belt tracking configured in accordance with various embodiments described herein.

FIG. 6 is a cross-sectional view of a device for controlling or inhibiting industrial belt tracking configured in accordance with various embodiments described herein.

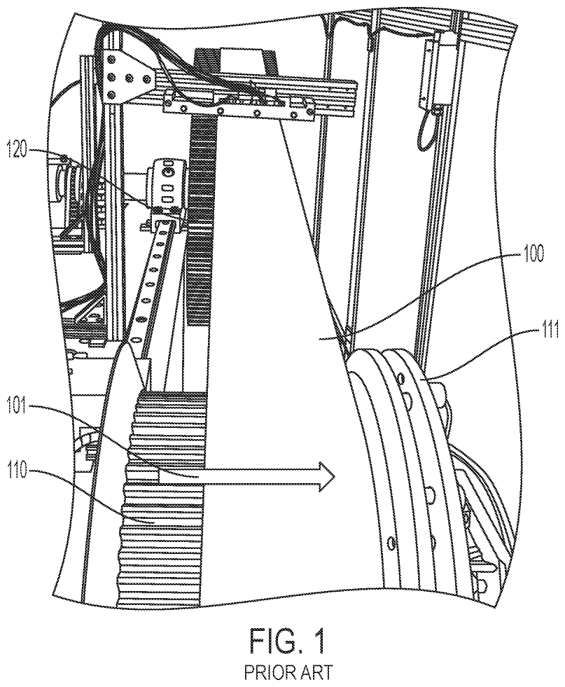

### DETAILED DESCRIPTION

Embodiments are described more fully below with reference to the accompanying Figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense.

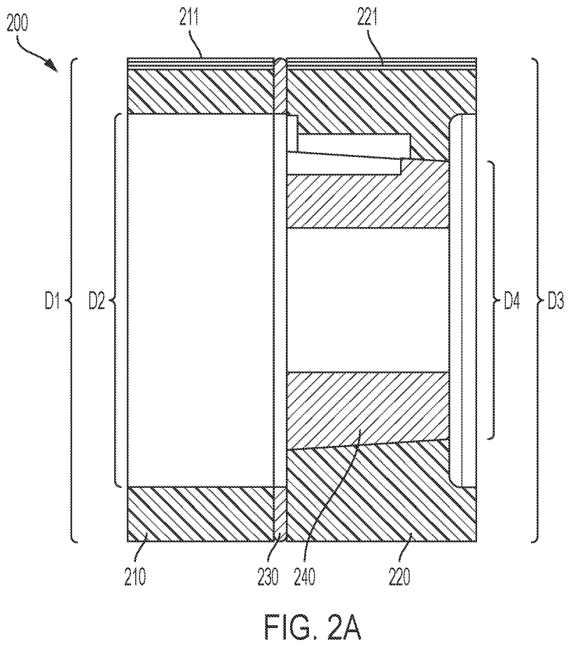

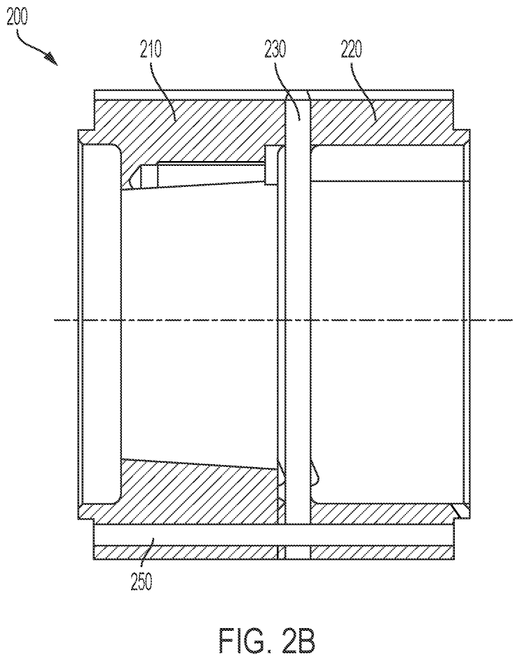

With reference to FIG. 2A, a cross-sectional view of a first embodiment of a device 200 for controlling or inhibiting industrial belt tracking is illustrated, the device 200 generally including a first cylindrical pulley segment 210, a second cylindrical pulley segment 220, and a flange ring 230. The first cylindrical pulley segment 210, second cylindrical pulley segment 220 and flange ring 230 each include a central opening, the central openings being coaxially aligned when the components 210, 220, 230 are assembled together to form device 200. Similarly, the outer diameter of each component 210, 220, 230 is approximately equal such that when assembled together along a common axis, the device 200 has a generally planar outer diameter surface that is aligned approximately parallel to the rotational axis of the device 200.

As also shown in FIG. 2A, the outer diameter surface of the first cylindrical pulley segment 210 and the second cylindrical pulley segment 220 have teeth 211, 221 formed therein, the teeth 211, 221 being generally oriented in parallel with the rotational axis of the device 200. The number, size, shape and spacing of the teeth 211, 221 on pulley segments 210, 220 may be identical such that each tooth 211 on first cylindrical pulley segment 210 can be aligned with a corresponding tooth 221 on second cylindrical pulley segment 220. While the flange ring 230 separates the teeth 211 from the teeth 221, pulley segments 210 and 220 may be aligned such that each individual tooth 211 on first cylindrical pulley segment 210 is aligned with a tooth 221 on second cylindrical pulley segment 220.

First cylindrical pulley segment 210 generally includes an outer diameter D1 measuring from the tips of the teeth 211 formed in the outer diameter surface of segment 210, and an inner diameter D2 defining the size of the opening formed through the middle of the first cylindrical pulley segment 210. The axial length of the first cylindrical pulley segment 210 is generally not limited and, in conjunction with the axial length of the second cylindrical pulley segment 220, may be selected based on the specific application in which the device 200 is used.

Second cylindrical pulley segment 220 generally includes an outer diameter D3 measuring from the tips of the teeth 221 formed in the outer diameter surface of pulley segment 220, with diameter D3 being approximately equal to diameter D1 of the first cylindrical pulley segment 210. Second cylindrical pulley segment 220 further includes a variable inner diameter D4 defining the opening formed through the middle of the second cylindrical pulley segment 220. The diameter of D4 may be variable along the axial length of the second cylindrical pulley segment 220 such that the opening in cylindrical pulley segment 220 is configured to receive a bushing 240 that can be used to secure the device 200 to a rotating shaft (not shown). While the specific bushing used with the device 200 is not limited, and the size and shape of the opening in pulley segment 220 can be adjusted to accommodate any type of bushing, FIG. 2A shows the opening in pulley segment 220 being sized and shape to accommodate a taper lock bushing 240. As such, the diameter D4 generally decreases from an interior end of pulley segment 220 towards an exterior end of pulley segment 220. The opening in pulley segment 220 can further be shaped to include recesses into which bolts used for securing the taper lock bushing to the device 200 and the rotating shaft can be inserted.

With reference to FIG. 2B, device 200 may further include a plurality of fasteners 250 extending through each of the first cylindrical pulley segment 210, the flange ring 230 and the second cylindrical pulley segment 220 for securing together these three components 210, 230, 220. The plurality of fasteners 250 may be spaced circumferentially around the device 200, including in an even or uneven spacing configuration. Any suitable number of fasteners 250 can be used for securing together the components 210, 220, 230. The specific type of fastener 250 is also not limited, and may include, e.g., bolts, screws or the like.

As shown in both FIG. 2A and 2B, flange ring 230 is generally disposed between pulley segments 210 and 220 such that the interior end of pulley segment 210 and the interior end of pulley segment 220 reside against the opposite sides of the flange ring 230. In some embodiments, the inner diameter of the flange ring 230 is approximately the same as diameter D2 of the first cylindrical pulley segment 210, while the inner diameter of the flange ring 230 is greater than the inner diameter D3 of the second segment at the interior side of the second cylindrical pulley segment 220. As shown in FIG. 2A, this allows for bolts used to secure bushing 240 to be passed through the opening in both the first cylindrical pulley segment 210 and the flange ring 230 and into the recesses formed in the opening of the second segment 220.

Flange ring 230 is generally designed to provide a flange oriented perpendicular to the axis of rotation of device 200 and extending around the entire circumference of the device 200. The outer diameter of flange ring 230 is generally sized to be approximately the same diameter as the diameter D1 of first pulley segment 210 and the outer diameter D3 of second pulley segment 220. In other words, the outer diameter edge of flange 230 is generally radially aligned with the plurality of teeth formed on the outside diameter surface of the first cylindrical pulley segment 210 and the second cylindrical pulley segment 220. However, some variance is permissible depending on the specific application of device 200 such that the outer diameter of flange ring 230 may be greater than, equal to, or less than diameter D1/D3. When the outer diameter of flange ring 230 is less than diameter D1/D3, the diameter of flange ring 230 should not be so small such that the flange ring does not at least partially overlap with the teeth 211, 221 formed in the outer diameter surface of the pulley segments 210, 220.

As shown in both FIGS. 2A and 2B, the flange ring 230 may be tapered at its outer diameter edge. As described in greater detail below, such tapering may provide for the outer diameter edge of the flange ring 230 to be more easily received within a groove formed in the industrial belt used in conjunction with device 200. The specific degree of the taper and depth of the taper are generally not limited, and may be adjusted based on the specific application of the device 200 and/or the dimensions of the groove formed in the belt used in conjunction with the device 200. Additionally, while FIGS. 2A and 2B show the outer diameter edge of the flange ring being flat or squared off, other shapes can also be used. For example, the outer diameter edge could be rounded or pointed. Furthermore, the outer diameter edge of flange ring 230 may not be tapered at all. For example, the outer diameter portion of the flange ring 230 could simply have a smaller thickness than the main body portion of the flange ring, but with the side walls of the outer diameter portion being oriented generally perpendicular to the rotational axis of the device 200.

As noted previously, the axial width of first pulley segment 210 and second pulley segment 220 is generally not limited. In some embodiments, the axial width of first pulley segment 210 is approximately equal to the axial width of second pulley segment 220, while in other embodiments, the axial width of the first pulley segment 210 is less than or greater than the axial width of the pulley segment 220. In such embodiments where the axial width of pulley segments 210, 220 are unequal, this generally provides a configuration where the flange ring 230 is off center along the axial width of device 200. For example, as shown in FIG. 2A, the axial width of first pulley segment 210 is less than the axial width of second pulley segment 220, and as such, the flange ring 230 is positioned off center to the left of the device 200. The axial width of the flange ring 230 is also generally not limited, though generally speaking, the axial width of the flange ring 230 is substantially smaller than the axial width of the either the first or second segment 210, 220.

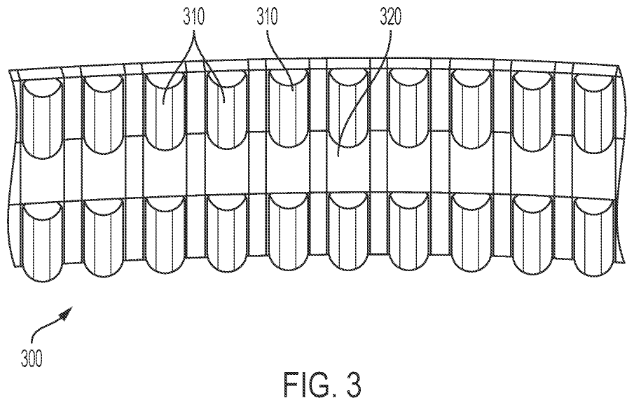

With reference now to FIG. 3, an industrial belt 300 suitable for use with various embodiments of a device for controlling or inhibiting industrial belt tracking described herein, including device 200 described previously and illustrated in FIGS. 2A and 2B, is illustrated. The belt 300 generally includes a plurality of protrusions 310 oriented perpendicular to the direction of rotation of the belt 300. The number, spacing, size and shape of protrusions 310 are generally designed such that the protrusions engage with and reside within the gaps between teeth 211, 221 in the outer diameter surface of pulley segments 210, 220. In this manner, rotation of the device 200 generally rotates the industrial belt 300 via engagement between the teeth 211, 221 and protrusions 310.

Industrial belt 300 further includes a groove 320 intersecting the protrusions 310 and aligned generally in parallel with the direction of rotation of the belt 300. The groove 320 is generally shaped and sized such that the outer diameter edge of the flange ring 230 is received within the groove 320 when the industrial belt 300 is used in conjunction with the device 200. In some embodiments, the width of groove 320 is slightly larger than the width of the outer diameter edge of the flange ring 230, and the depth of the groove is approximately equal to the outer edge portion of the flange ring 230 that is sized and shaped to reside within the groove 320.

When the belt 300 is used in conjunction with device 200, tracking (i.e., lateral movement of the belt 300 on an associated pulley) is generally inhibited by virtue of the flange ring 230 and the groove 320 in belt 300 working together to prevent lateral movement of the belt 300. For example, if the belt 300 begins to track to the right of left, the outer diameter edge of the flange ring 230 disposed in the groove 320 abuts against the sides of the protrusions 310 in the belt (i.e., the sides of the groove 320), which impedes further movement of the belt 300 to the left or right.

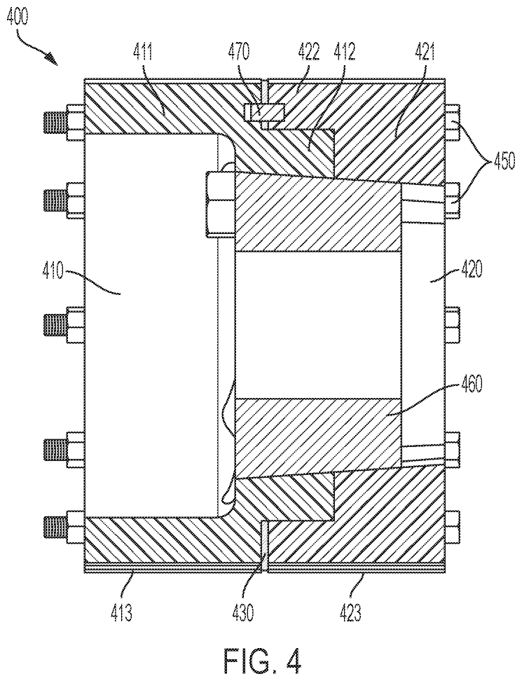

With reference to FIG. 4, another embodiment of a device 400 for controlling or inhibiting industrial belt tracking is illustrated. Device 400 generally includes a first cylindrical pulley segment 410, a second cylindrical pulley segment 420, and a flange ring 430. The first cylindrical pulley segment 410, second cylindrical pulley segment 420 and flange ring 430 each include a central opening, the central openings being coaxially aligned when the components 410, 420, 430 are assembled together to form device 400. At least a portion of each component 410, 420, 430 has an outer diameter that is approximately equal such that when assembled together along a common axis, the device 400 has a generally planar outer diameter surface that is aligned approximately parallel to the rotational axis of the device 400.

First cylindrical pulley segment 410 generally includes two main sections: a first cylindrical base portion 411 and a first cylindrical flange portion 412. The first cylindrical base portion 411 is generally located at an exterior end of the pulley segment 410, while the first cylindrical flange portion 412 is generally located at an interior end of the pulley segment 410 opposite the exterior end. The flange portion 412 is connected to the base portion 411 proximate an interior end of the base portion 411 and extends axially away from the interior end of the base portion 411. The base portion 411 includes an inner diameter that defines the central opening of the base portion 411, and an outer diameter. The flange portion 412 includes an inner diameter that defines the central opening of the flange portion 412 and which is less than the inner diameter of the base portion 411. The flange portion 412 further includes an outer diameter that is less than the outer diameter of the base portion 411. In this manner, the segment 410 takes on a Z-type shape including a “step” or “ledge” at the radial outer side of the intersection of the base portion 411 and the flange portion 412.

The second cylindrical pulley segment 420 similarly includes two main sections: a second cylindrical base portion 421 and a second cylindrical flange portion 422. The second cylindrical base portion 421 is generally located at an exterior end of the pulley segment 420, while the second cylindrical flange portion 422 is generally located at an interior end of the pulley segment 420 opposite the exterior end. The flange portion 422 extends axially away from the interior end of the base portion 421. The base portion 421 includes an inner diameter that defines the central opening of the base portion 421, and an outer diameter. The outer diameter of base portion 421 is approximately equal to the outer diameter of the base portion 411 to thereby form a portion of the planar outer diameter surface of the device 400 as mentioned previously. The flange portion 422 includes an inner diameter that defines the central opening of the flange portion 422 and which is greater than the inner diameter of the base portion 421. The flange portion 422 further includes an outer diameter that is approximately equal to the outer diameter of the base portions 411, 421. In this manner, the pulley segment 420 includes a “step” or “ledge” at the radially inner side of the intersection of the base portion 421 and the flange portion 422.

Flange ring 430 has an inner diameter defining a central opening in the ring 430 that is approximately equal to the outer diameter of the flange portion 412, and an outer diameter that is approximately equal to the outer diameter of the base portions 411, 421 and flange portion 422. As with flange ring 230, flange ring 430 is generally designed to provide a flange oriented perpendicular to the axis of rotation of device 400 and extending around the entire circumference of the device 400.

When assembled together, flange ring 430 is disposed between first pulley segment 410 and second pulley segment 420. More specifically, flange ring 430 is sized such that first cylindrical flange portion 412 extends through the opening in flange ring 430, and the flange ring 430 can be positioned to rest against the interior end of the first cylindrical base portion 411. When device 400 is assembled, the interior end of flange portion 422 resides against the flange ring 430 such that the flange ring 430 is sandwiched between the interior end of base portion 411 and the interior end of flange portion 422. Furthermore, the “ledge” in segment 410 is sized and shaped to mate with the “ledge” in pulley segment 420 such that the radial inner surface of the flange portion 422 resides against radial outer surface of the flange portion 412 when device 400 is assembled.

The outer diameter surface of the base portion 411 and the outer diameter surface of the flange portion 422 and base portion 421 have teeth 413, 423 formed therein, the teeth 413, 423 being generally oriented in parallel with the rotational axis of the device 400. The number, size, shape and spacing of the teeth 413, 423 on pulley segments 410, 420 may be identical such that each tooth 413 on segment 410 can be aligned with a corresponding tooth 423 on pulley segment 420. While the flange ring 430 separates the teeth 413 from the teeth 423, pulley segments 410 and 420 may be aligned such that each individual tooth 413 on segment 410 is aligned with a tooth 423 on pulley segment 420.

The outer diameter of flange ring 430 is generally sized to be approximately the same diameter as the outer diameter of the base portion 411, flange portion 422 and base portion 421. In other words, the outer diameter edge of flange ring 430 is approximately radially aligned with the plurality of teeth 413, 423 formed on the outside diameter surface of the first cylindrical pulley segment 410 and the second cylindrical pulley segment 430. However, some variance is permissible depending on the specific application of device 400 such that the outer diameter of flange ring 430 may be greater than, equal to, or less than the outer diameter of pulley segments 410 and 420. When the outer diameter of flange ring 430 is less than the outer diameter of pulley segment 410, 420, the outer diameter of flange ring 430 should not be so small such that the flange ring 430 does not at least partially overlap with the teeth 413, 423 formed in the outer diameter surface of the pulley segments 410, 420.

The shape of the outer edge of the flange ring 430 is generally not limited and may be similar or identical to the shape of the outer edge of flange ring 230 as described in more detail previously. For example, the outer edge of flange ring 430 may include a taper as described previously, may have a rounded, pointed, or squared off shape as described previously, etc. Ultimately, the shape and size of the outer edge of flange ring 230 is designed so that it may be accommodated in the groove formed in the industrial belt used with the device 400 as described in more detail previously with respect to FIG. 3.

Device 400 may further include a plurality of fasteners 450 extending through each of the first cylindrical pulley segment 410, the flange ring 430 and the second cylindrical pulley segment 420 for securing together these three components 410, 430, 420. The plurality of fasteners 450 may be spaced circumferentially around the device 400, including in an even or uneven spacing configuration. Any suitable number of fasteners 450 can be used for securing together the components 410, 420, 430. The specific type of fastener 450 is also not limited, and may include, e.g., bolts, screws or the like.

With reference to the central opening of device 400, FIG. 4 illustrates how the inner diameter surface of the flange portion 412 and the inner diameter surface of base portion 421 can be shaped to accommodate a bushing 460, such as a taper lock bushing. In some embodiments, the combined inner diameter surface of flange portion 412 and base portion 421 forms a continuous inner diameter surface that has a gradually decreasing diameter in a direction from the flange portion 412 towards the base portion 421. This creates a sloping inner surface specifically configured for receiving a bushing 460 such as a taper lock bushing. This inner surface can also include recesses for receiving bolts used with the bushing 460 to secure the bushing to the device 400 and a rotating shaft (not shown). Because the bushing 460 extends axially across both the first segment 410 and the second segment 420 when installed in the device 400, the bushing 460 supports both halves of device 400 in a radial direction, which can eliminate bending load on the fasteners 450 used to join together the components of the device 400.

The inner diameter of the base portion 411 being larger than the inner diameter of the flange portion 412 allows for the bushing 460 to be installed in the device 400 by passing it through the opening in the first segment 410 until it engages with the inner surface of the flange portion 412 and the base portion 421 configured for receiving the bushing 460. In some embodiments and as shown in FIG. 4, the inner diameter of base portion 411 may be constant to there by create parallel inner diameter side walls for the opening in the base portion 411 of segment 410.

FIG. 4 further illustrates that the device 400 may include one or more dwell pins 470 to further secure together and/or align components of the device 400. These dwell pins 470 are generally located within the device 400, rather than extending all the way through the device as with the fasteners 450. FIG. 4 illustrate one dwell pin 470 extending axially through the flange ring 430 and partially into portions of pulley segments 410 and 420 (specifically into base portion 411 and flange portion 422). Any number of dwell pins 470 may be used, and the dwell pins may be located circumferentially around the device in an evenly or unevenly space configuration.

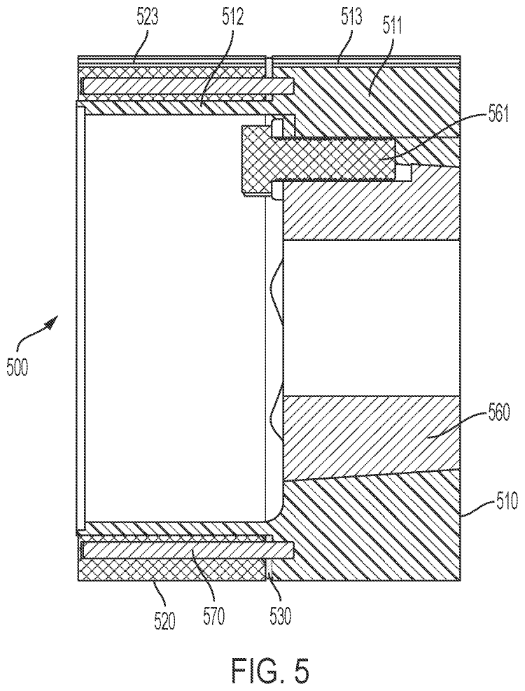

With reference to FIG. 5, another embodiment of a device 500 for controlling or inhibiting industrial belt tracking is illustrated. Device 500 generally includes a first cylindrical pulley segment 510, a second cylindrical pulley segment 520, and a flange ring 530. The first cylindrical pulley segment 510, second cylindrical pulley segment 520 and flange ring 530 each include a central opening, the central openings being coaxially aligned when the components 510, 520, 530 are assembled together to form device 500. Each component 510, 520, 530 has an outer diameter that is approximately equal such that when assembled together along a common axis, the device 500 has a generally planar outer diameter surface that is aligned approximately parallel to the rotational axis of the device 500.

First cylindrical pulley segment 510 generally includes two main sections: a first cylindrical base portion 511 and a first cylindrical flange portion 512. The first cylindrical flange portion 512 extends axially away from an interior end of the base portion 511. The base portion 511 includes an inner diameter that defines the central opening of the base portion 511, and an outer diameter. The flange portion 512 includes an inner diameter that defines the central opening of the flange portion 512 and which is greater than the inner diameter of the base portion 511. The flange portion 512 further includes an outer diameter that is less than the outer diameter of the base portion 511. In this manner, the pulley segment 510 includes a “recess” radially outside of the outer diameter side of the flange portion 512 which, as described in greater below, is configured to receive the second cylindrical pulley segment 520 and the flange ring 530.

The second cylindrical pulley segment 520 includes an inner diameter that defines the central opening of the pulley segment 520. The inner diameter of segment 520 is approximately equal to the outer diameter of flange portion 512 such that the flange portion 512 can extend through the opening in the pulley segment 520, with the inner diameter surface of the pulley segment 520 residing against the outer diameter surface of the flange portion 512. The pulley segment 520 further includes an outer diameter, with the outer diameter of pulley segment 520 being approximately equal to the outer diameter of the base portion 511 to thereby form a planar outer diameter surface of the device 500 when the first and second pulley segments 510 and 520 are assembled together.

Flange ring 530 has an inner diameter defining a central opening in the ring 530 that is approximately equal to the outer diameter of the flange portion 512, and an outer diameter that is approximately equal to the outer diameter of the base portions 511 and the second segment 520. As with previously described flange ring 230 and flange ring 430, flange ring 530 is generally designed to provide a flange oriented perpendicular to the axis of rotation of device 500 and extending around the entire circumference of the device 500.

When assembled together, flange ring 530 is disposed between the base portion 511 of pulley segment 510 and pulley segment 520. More specifically, flange ring 530 is sized such that first cylindrical flange portion 512 extends through the opening in flange ring 530, and the flange ring 530 can be positioned to rest against the interior end of the first cylindrical base portion 511. When device 500 is assembled, flange portion 512 also extends through the opening in pulley segment 520, and the interior end of segment 520 resides against the flange ring 530 such that the flange ring 530 is sandwiched between the interior end of base portion 511 and the pulley segment 520. Furthermore, the “recess” in pulley segment 510 is sized and shaped to receive segment 520 such that the recess is predominantly occupied by the pulley segment 520 and the flange ring 520 and the interior diameter surface of pulley segment 520 resides against the outer diameter surface of flange portion 512 when device 500 is assembled.

The outer diameter surface of the base portion 511 and the outer diameter surface of the second pulley segment 520 have teeth 513, 523 formed therein, the teeth 513, 523 being generally oriented in parallel with the rotational axis of the device 500. The number, size, shape and spacing of the teeth 513, 523 on pulley segments 510, 520 may be identical such that each tooth 513 on segment 510 can be aligned with a corresponding tooth 523 on pulley segment 520. While the flange ring 530 separates the teeth 513 from the teeth 523, pulley segments 510 and 520 may be rotationally aligned such that each individual tooth 513 on segment 510 is aligned with a tooth 523 on pulley segment 520.

The outer diameter of flange ring 530 is generally sized to be approximately the same diameter as the outer diameter of the base portion 511 and segment 520. In other words, the outer diameter edge of flange 530 is approximately radially aligned with the plurality of teeth 513, 523 formed on the outside diameter surface of the first cylindrical pulley segment 510 and the second cylindrical pulley segment 520. However, some variance is permissible depending on the specific application of device 500 such that the outer diameter of flange ring 530 may be greater than, equal to, or less than the outer diameter of pulley segments 510 and 520. When the outer diameter of flange ring 530 is less than the outer diameter of pulley segment 510, 520, the outer diameter of flange ring 530 should not be so small such that the flange ring 530 does not at least partially radially overlap with the teeth 513, 523 formed in the outer diameter surface of the pulley segments 510, 520.

The shape of the outer edge of the flange ring 530 is generally not limited and may be similar or identical to the shape of the outer edge of flange ring 230 and flange ring 430 as described in more detail previously. For example, the outer edge of flange ring 530 may include a taper as described previously, may have a rounded, pointed, or squared off shape as described previously, etc. Ultimately, the shape and size of the outer edge of flange ring 530 is designed so that it may be accommodated in the groove formed in the industrial belt used with the device 500 as described in more detail previously with respect to FIG. 3.

Device 500 may further include a plurality of fasteners (not shown in FIG. 5) extending through each of the first cylindrical pulley segment 510, the flange ring 530 and the second cylindrical pulley segment 520 for securing together these three components 510, 530, 520. Alternatively, the device 500 may not require such fasteners to secure together the components and may therefore be free of such fasteners.

With reference to the central opening of device 500, FIG. 5 illustrates how the inner diameter surface of the base portion 511 can be shaped to accommodate a bushing 560, such as a taper lock bushing. In some embodiments, the inner diameter surface of base portion 511 has a gradually decreasing diameter in a direction from the interior end of the pulley segment 510 to the exterior end of the pulley segment 510. This creates a sloping inner surface specifically configured for receiving a bushing 560 such as a taper lock bushing. This inner surface can also include recesses for receiving bolts used with the bushing 560 to secure the bushing to the device 500 and a rotating shaft (not shown), such as bolt 561 shown in FIG. 5.

The inner diameter of the flange portion 512 being larger than the inner diameter of the base portion 511 allows for the bushing 560 to be installed in the device 500 by passing it through the portion of the central opening defined by the flange portion 512 until it engages with the inner surface of the base portion 511 configured for receiving the bushing 560. In some embodiments and as shown in FIG. 5, the inner diameter of flange portion 512 may be constant to thereby create parallel inner diameter side walls for the central opening defined by the flange portion 512.

FIG. 5 further illustrates that the device 500 may include one or more dwell pins 570 to secure together and/or align components of the device 500. These dwell pins 570 are generally located within the device 500, rather than extending all the way through the device. FIG. 5 illustrates two dwell pins 570 extending axially through the flange ring 530 and partially into portions of pulley segments 510 and 520 (specifically into base portion 511). Any number of dwell pins 570 may be used, and the dwell pins may be located circumferentially around the device in an evenly or unevenly space configuration.

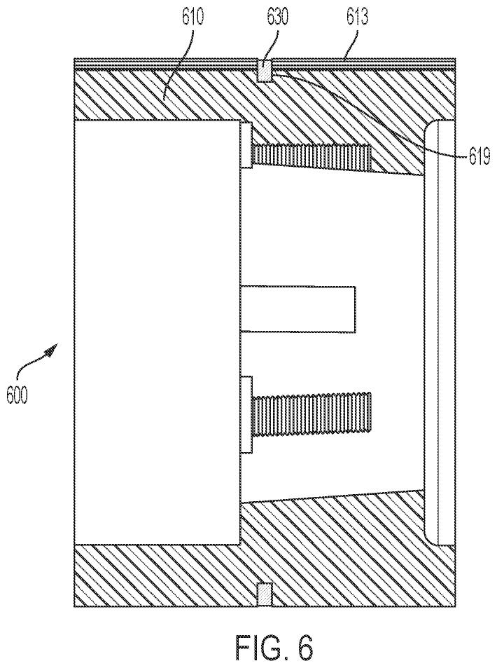

With reference to FIG. 6, another embodiment of a device 600 for controlling or inhibiting industrial belt tracking is illustrated. Device 600 generally includes a first cylindrical pulley segment 610 and a flange ring 630. The first cylindrical pulley segment 610 and flange ring 630 each include a central opening, the central openings being coaxially aligned when the components 610, 630 are assembled together to form device 600.

First cylindrical pulley segment 610 generally is a unitary cylindrical component having a central opening extending axially through the center of the pulley segment 610. As such, the pulley segment 610 includes an outer diameter and an inner diameter. The outer diameter is constant across the axial width of the device to thereby form a generally planar outer diameter surface that is oriented parallel to the rotational axis of the device 600.

In contrast, the inner diameter of pulley segment 610 is variable across the axial width of the device 600. From a first axial end of the device to an intermediate point between the first axial end and the second (opposite) axial end, the inner diameter is constant to thereby form inner diameter side walls that are aligned parallel to the rotational axis of the device 600. At the intermediate point, the inner diameter becomes smaller and is then shaped and configured from the intermediate point to the opposite axial end of the device 600 such that a bushing (not shown) can be received in the central opening. For example, and as shown in FIG. 6, the inner diameter may decrease from the intermediate point towards the second axial end to create an inwardly sloping inner diameter surface that can receive a bushing such as a taper lock bushing. As also shown in FIG. 6, this portion of the inner diameter surface may further be shaped to include recesses for receiving bolts used to secure the bushing to the device 600 and a rotational shaft (not shown).

A groove 619 is formed in the outer diameter surface of the segment 610, the groove extending into the pulley segment 610 in a direction generally perpendicular to the rotational axis of the device 600. The groove 619 also extends circumferentially around the entirety of the device 600. The specific depth, width and shape of the groove 619 is generally not limited provided that the size and shape of the groove 619 allows for the flange ring 630 to be disposed in the groove 619.

Flange ring 630 has an inner diameter defining a central opening in the ring 630 that is approximately equal to the diameter of the pulley segment 610 at the bottom of groove 619. The outer diameter of flange ring 630 is approximately equal to the outer diameter of the segment 610. As with previously described flange ring 230, flange ring 430, and flange ring 530, flange ring 630 is generally designed to provide a flange oriented perpendicular to the axis of rotation of device 600 and extending around the entire circumference of the device 600.

In some embodiments, the flange ring 630 is constructed of multiple arc segments such that it can be easily installed in the groove 619. The flange ring 630 can be constructed of two more pieces. Once the multi-part flange ring is disposed in the groove 619, the separate pieces of the flange ring 630 can be secured together, such as through the use of fasteners or by welding or otherwise fusing together ends of the individual pieces. Alternatively, or in conjunction with securing together the pieces of the flange ring 630, the individual pieces of the flange ring 630 can be secured to the side and/or bottom walls of the groove 619. Any means for securing the pieces of the flange ring 630 to the walls of the groove 619 can be used, such as through the use of fasteners, or by fusing, brazing, or welding the flange ring 630 to the walls of the groove 619.

The outer diameter surface of the pulley segment 610 has teeth 613 formed therein, the teeth 613 being generally oriented in parallel with the rotational axis of the device 600. The teeth extend the entire axial width of the device 600, but are interrupted by the groove formed in the pulley segment 610.

The outer diameter of flange ring 630 is generally sized to be approximately the same diameter as the outer diameter of the pulley segment 610. In other words, the outer diameter edge of flange 630 is approximately radially aligned with the plurality of teeth 613 formed on the outside diameter surface of the pulley segment 610. However, some variance is permissible depending on the specific application of device 600 such that the outer diameter of flange ring 630 may be greater than, equal to, or less than the outer diameter of pulley segment 610. When the outer diameter of flange ring 630 is less than the outer diameter of pulley segment 610, the outer diameter of flange ring 630 should not be so small such that the flange ring 630 does not at least partially radially overlap with the teeth 613 formed in the outer diameter surface of the pulley segment 610.

The shape of the outer edge of the flange ring 630 is generally not limited and may be similar or identical to the shape of the outer edge of flange ring 230, flange ring 430, and flange ring 530 as described in more detail previously. For example, the outer edge of flange ring 630 may include a taper as described previously, may have a rounded, pointed, or squared off shape as described previously, etc. Ultimately, the shape and size of the outer edge of flange ring 630 is designed so that it may be accommodated in the groove formed in the industrial belt used with the device 600 as described in more detail previously with respect to FIG. 3.

The specific location of the groove 619 along the axial width of the segment 610 is generally not limited. As shown in FIG. 6, the groove 619 is approximately centered along the axial width of the device 600. However, the groove 619 could also be located off center to the left or to the right.

The device designs shown in FIGS. 2A, 2B, 4 and 5 are each shown as including two pulley segments and one flange ring. However, it should be appreciated that these designs can be modified to include more than two pulley segments, with a flange ring positioned between each pair of adjacent segments. For example, if the device shown in FIG. 2A were modified to include three pulley segments, a flange ring could be disposed between the first and second segments and between the second and third segments. In such modifications, the industrial belt used with the device would include a groove for each flange ring so that each flange could be disposed in a corresponding groove in the industrial belt to prevent or inhibit tracking.

Similarly, the device shown in FIG. 6 shows a single groove and a single flange ring disposed therein. However, it should be appreciated that this design can be modified to include more than one groove and more than flange ring. For example, two axially spaced apart grooves can be formed in the pulley segment, and a flange ring can be disposed in each ring. In such modifications, the industrial belt used with the device would include a groove for each flange ring so that each flange could be disposed in a corresponding groove in the industrial belt to prevent or inhibit tracking.

From the foregoing, it will be appreciated that specific embodiments of the invention have been described herein for purposes of illustration, but that various modifications may be made without deviating from the scope of the invention. Accordingly, the invention is not limited except as by the appended claims.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended.

Unless otherwise indicated, all number or expressions, such as those expressing dimensions, physical characteristics, etc., used in the specification (other than the claims) are understood as modified in all instances by the term “approximately”. At the very least, and not as an attempt to limit the application of the doctrine of equivalents to the claims, each numerical parameter recited in the specification or claims which is modified by the term “approximately” should at least be construed in light of the number of recited significant digits and by applying rounding techniques. Moreover, all ranges disclosed herein are to be understood to encompass and provide support for claims that recite any and all sub-ranges or any and all individual values subsumed therein. For example, a stated range of 1 to 10 should be considered to include and provide support for claims that recite any and all sub-ranges or individual values that are between and/or inclusive of the minimum value of 1 and the maximum value of 10; that is, all sub-ranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

1. A device for controlling or inhibiting industrial belt tracking comprising:
a first cylindrical pulley segment having a central opening and a plurality of teeth formed on the outside diameter surface thereof;
a second cylindrical pulley segment having a central opening and having a plurality of teeth formed on the outside diameter surface thereof; and
a flange ring, the flange ring being disposed between the first cylindrical pulley segment and the second cylindrical pulley segment such that the flange ring, the first cylindrical pulley segment and the second cylindrical pulley segment are coaxially aligned;
wherein the flange ring is shaped and sized such that the outer diameter edge of the flange ring provides a flange oriented perpendicular to the orientation of the plurality of teeth formed on the outside diameter surface of the first cylindrical pulley segment and the second cylindrical pulley segment and generally radially aligned with the plurality of teeth formed on the outside diameter surface of the first cylindrical pulley segment and the second cylindrical pulley segment.

2. The device of claim 1, further comprising:
a plurality of fasteners, each fastener extending axially through the first cylindrical pulley segment, the second cylindrical pulley segment and the flange ring, the plurality of fasteners spaced circumferentially around the device.

3. The device of claim 1, wherein the axial width of the first cylindrical pulley segment is approximately equal to the axial width of the second cylindrical pulley segment such that the flange ring is approximately centered on the axial width of the device.

4. The device of claim 1, wherein the axial width of the first cylindrical pulley segment is different from the axial width of the second cylindrical pulley segment such that the flange ring is off center along the axial width of the device.

5. The device of claim 1, wherein the central opening of the first cylindrical pulley segment is shaped and sized to receive a bushing and the central opening of the second cylindrical pulley segment has a diameter larger that then the outer diameter of the bushing to be disposed in the central opening of the first cylindrical pulley segment.

6. The device of claim 1, wherein the central opening of the first cylindrical pulley segment and the central opening of the first cylindrical pulley segment are both shaped and sized to receive a bushing such that when disposed therein, the bushing overlaps axially with both the first cylindrical pulley segment and the second cylindrical pulley segment.

7. The device of claim 1, wherein the outer diameter of the flange ring is greater than the outer diameter of the plurality of teeth formed on the outside diameter surface of the first cylindrical pulley segment and the second cylindrical pulley segment.

8. (canceled)

9. The device of claim 1, wherein the outer diameter of the flange ring is less than the outer diameter of the plurality of teeth formed on the outside diameter surface of the first cylindrical pulley segment and the second cylindrical pulley segment.

10. A device for controlling or inhibiting industrial belt tracking comprising:
a first cylindrical pulley segment, comprising:
a first cylindrical base portion having an outer diameter and an inner diameter; and
a first cylindrical flange portion extending axially away from an interior end of the first cylindrical base portion, the first cylindrical flange portion having an inner diameter less than the inner diameter of the first cylindrical base portion and an outer diameter less than the outer diameter of the first cylindrical base portion;
a second cylindrical pulley segment, comprising:
a second cylindrical base portion having an inner diameter and an outer diameter; and
a second cylindrical flange portion having an outer diameter approximately equal to the outer diameter of the second cylindrical base portion and an inner diameter greater than the inner diameter of the second cylindrical base portion; and
a flange ring having an inner diameter approximately equal to the outer diameter of the first cylindrical flange portion and an outer diameter approximately equal to the outer diameter of the first cylindrical base portion and the second cylindrical flange portion;
wherein the inner diameter surface of the second cylindrical flange portion resides against the outer diameter surface of the first cylindrical flange portion and the flange ring is disposed between the interior end of the first cylindrical base portion and an interior end of the second cylindrical flange portion.

11. The device of claim 10, wherein a plurality of teeth oriented parallel to the axis of rotation of the device are formed on the outer diameter surface of the first cylindrical base portion, the second cylindrical flange portion and the second cylindrical base portion.

12. The device of claim 10, further comprising a plurality of fasteners, each fastener extending axially through the first cylindrical pulley segment, the second cylindrical pulley segment and the flange ring, the plurality of fasteners spaced circumferentially around the device.

13. (canceled)

14. The device of claim 10, wherein the inner diameter surface of the first cylindrical flange portion and the inner diameter surface of the second cylindrical base portion are shaped and sized to receive a bushing such that when the bushing is disposed therein, the bushing extends through a portion of the first cylindrical pulley segment and a portion of the second cylindrical pulley segment.

15. The device of claim 10, wherein the outer diameter of the flange ring is greater than the outer diameter of the plurality of teeth formed on the outside diameter surface of the first cylindrical base portion, the second cylindrical flange portion and the second cylindrical base portion.

16. The device of claim 10, wherein the outer diameter of the flange ring is less than the outer diameter of the plurality of teeth formed on the outside diameter surface of the first cylindrical base portion, the second cylindrical flange portion and the second cylindrical base portion.

17. (canceled)

18. A device for controlling or inhibiting industrial belt tracking comprising
a first cylindrical pulley segment, comprising:
a first cylindrical base portion having an outer diameter and an inner diameter; and
a first cylindrical flange portion extending axially away from an interior end of the first cylindrical base portion, the first cylindrical flange portion having an inner diameter greater than the inner diameter of the first cylindrical base portion and an outer diameter less than the outer diameter of the first cylindrical base portion;
a second cylindrical pulley segment comprising an inner diameter approximately equal to the outer diameter of the first cylindrical flange portion and an outer diameter approximately equal to the outer diameter of the first cylindrical base portion;
wherein the axial length of the second cylindrical pulley segment is approximately equal to the axial length of the first cylindrical flange portion; and
a flange ring having an inner diameter approximately equal to the outer diameter of the first cylindrical flange portion and an outer diameter approximately equal to the outer diameter of the first cylindrical base portion;
wherein the inner diameter surface of the second cylindrical pulley segment resides against the outer diameter surface of the first cylindrical flange portion and the flange ring is disposed between the interior end of the first cylindrical base portion and an interior end of the second cylindrical pulley segment.

19. The device of claim 18, wherein a plurality of teeth oriented parallel to the axis of rotation of the device are formed on the outer diameter surface of the first cylindrical base portion and the second cylindrical pulley segment.

20. The device of claim 18, further comprising a plurality of dwell pins, each of the dwell pins extending through the flange ring and to a location within the second cylindrical pulley segment and the first cylindrical base portion.

21. The device of claim 18, wherein the inner diameter surface of the first cylindrical base portion is shaped and sized to receive a bushing such that when the bushing is disposed therein, the bushing extends only through a portion of the first cylindrical pulley segment.

22. The device of claim 18, wherein the outer diameter of the flange ring is greater than the outer diameter of the plurality of teeth formed on the outside diameter surface of the first cylindrical base portion and the second cylindrical pulley segment.

23. The device of claim 18, wherein the outer diameter of the flange ring is less than the outer diameter of the plurality of teeth formed on the outside diameter surface of the first cylindrical base portion and the second cylindrical pulley segment.

24.-32. (canceled)
